(19) United States
(12) Patent Application Publication
(10) Pub. No.: US 2003/0194999 A1
(43) Pub. Date: Oct. 16, 2003

(54) Method and apparatus for reestablishing crypto-sync synchronization in a communication system

(76) Inventors: Roy Franklin Quick JR., San Diego, CA (US); Sai Yiu Duncan Ho, San Diego, CA (US); Jun Wang, San Diego, CA (US)

Correspondence Address: Qualcomm Incorporated, Patents Department, 5775 Morehouse Drive, San Diego, CA, 92121-1714, US

(21) Appl. No.: 10/123,922

(22) Filed: Apr. 16, 2002

(51) Int. Cl. H04M 1/66; H04M 1/68; H04M 3/16; H04Q 7/20

(52) U.S. Cl. 455/435.1; 455/411

(57) ABSTRACT

For reestablishing crypto-sync synchronization between a mobile station and a base station in a communication system (100), after establishing an initial crypto-sync synchronization through a registration and acceptance order process (701), the base station may detect loss of the initial crypto-sync synchronization. As a result, the mobile station may receive a base station reject order message (704). In response, the mobile station transmits a security mode request message (705) to the base station. The security mode request message (705) includes a full form of crypto-sync data for reestablishing crypto-sync synchronization between the mobile station and the base station without going through another round of the registration and acceptance order process (701).

### FIELD

The present invention relates generally to the field of communications, and more particularly, to communications in a cellular communication system.

### BACKGROUND

A communication system has many different components and requirements. One of the features of the system is providing message integrity of the communication between a mobile station and a base station. Message integrity guarantees the legitimacy of the sender of the message. To achieve message integrity, an Authentication and Key Agreement (AKA) procedure has been developed and defined in the relevant sections of the standards defining various operational requirements of the communication system. An Authentication Center (AC) is a component of the system that manages the authentication information related to the mobile stations operating in the system. An interface between a mobile switching center (MSC) and the AC may be utilized for the AKA procedure. The protection provided by the message integrity may be combined with the protection provided by encryption of the communicated messages. Since the communications may be over a number of messages communicated over a number of transmissions, each transmission includes a crypto-sync data. The crypto-sync data comprised of a sequence number. The sequence number is sequentially increased for each transmission. After or during the process of establishing a secure communication through the AKA procedure, the sender and the receiver synchronize the sequence number of the crypto-sync data. If the sender and the receiver fail to maintain matching crypto-sync data, the message integrity and encryption may also fail. Normally, when the crypto-sync data fails to match at the receiver, the crypto-sync synchronization is lost. The sender and receiver may start the AKA procedure to reestablish the crypto-sync synchronization. The communication resources are not used efficiently when re-starting the AKA procedure is due to failure of crypto-sync synchronization.

To this end as well as others, there is a need for a method and apparatus to allow reestablishing of crypto-sync synchronization without re-starting the AKA procedure.

### SUMMARY

In a communication system, a method and apparatus provides for reestablishing of crypto-sync synchronization between a mobile station and a base station after establishing an initial crypto-sync synchronization. The initial crypto-sync synchronization may be through a registration and acceptance order process. The base station may detect loss of the initial crypto-sync synchronization due to many different factors including poor communication link. The mobile station may receive a base station reject order message after loss of the initial crypto-sync synchronization. In response, the mobile station transmits a security mode request message (SMRM) to the base station. The SMRM includes a full form of crypto-sync data for reestablishing crypto-sync synchronization between the mobile station and the base station without going through another round of the registration and acceptance order process.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates a communication system capable of operating in accordance with various embodiments of the invention;

FIG. 2 illustrates a communication system receiver for receiving and decoding received data at a data rate in accordance with various aspects of the invention;

FIG. 3 illustrates a communication system transmitter for transmitting data packets at a scheduled data rate in accordance with various aspects of the invention;

FIG. 4 illustrates a transceiver system for maintaining a communication link between a mobile station and a base station while operating in accordance with various aspects of the invention for establishing and reestablishing the crypto-sync synchronization between the mobile station and base station;

FIG. 5 illustrates an exemplary process for authentication and key set-up procedures in a communication system;

FIG. 6 illustrates the process for generating a packet of data having partial or full crypto-sync data; and

FIG. 7 illustrates the process for establishing, detecting loss and reestablishing of the crypto-sync synchronization between the mobile station and base station in accordance with various aspects of the invention.

### DETAILED DESCRIPTION OF THE PREFERRED EMBODIMENT(S)

Various embodiments of the invention may be incorporated in a wireless communication system operating in accordance with the code division multiple access (CDMA) technique which has been disclosed and described in various standards published by the Telecommunication Industry Association (TIA) and other standards organizations. CDMA communication systems are evolving from an early generation to a more advanced generation. One of the early generation systems operates in accordance with the parameters defined in the TIA/EIA-95A/B standard, incorporated by reference herein. One of the more advanced systems operates in accordance with the TIA/EIA-IS-2000-A standard, incorporated by reference herein. At the time of this application for a patent, a newer version of the TIA/EIA-IS-2000-A standard is under development and being released under TIA/EIA-IS-2000-B standard, incorporated by reference herein. A copy of the standards may be obtained by accessing the world wide web at the address: http:f/www.3qpp2.org, or by writing to TIA, Standards and Technology Department, 2500 Wilson Boulevard, Arlington, Va. 22201, United States of America.

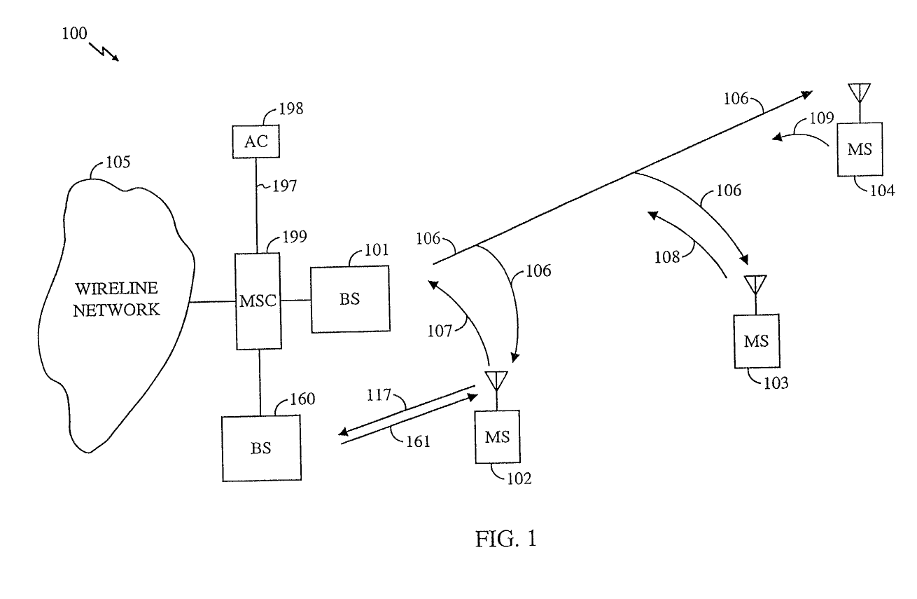

FIG. 1 illustrates a general block diagram of a communication system 100 capable of operating in accordance with any of the code division multiple access (CDMA) communication system standards while incorporating various embodiments of the invention. Communication system 100 may be for communications of voice, data or both. Generally, communication system 100 includes a base station 101 that provides communication links between a number of mobile stations, such as mobile stations 102-104, and between the mobile stations 102-104 and a public switch telephone and data network 105. The mobile stations in FIG. 1 may be referred to as data access terminals and the base station as data access network without departing from the main scope and various advantages of the invention. Base station 101 may include a number of components, such as a base station controller and a base transceiver system. For simplicity, such components are not shown. Base station 101 may also be in communication with other base stations, for example base station 160. A mobile station controller (MSC) 199 coupled to base stations 101 and 160 may control various operating aspects of the communication system 100. An authentication center (AC) 198 may be in communication with the MSC 199 for performing the management of the authentication services provided in the system 100. An interface 197 between AC 198 and MSC 199 provides the communication medium for communications of relevant information relating to the authentication process.

Base station 101 communicates with each mobile station that is in its coverage area via a forward link signal transmitted from base station 101. The forward link signals targeted for mobile stations 102-104 may be summed to form a forward link signal 106. Each of the mobile stations 102-104 receiving forward link signal 106 decodes the forward link signal 106 to extract the information that is targeted for its user. Base station 160 may also communicate with the mobile stations that are in its coverage area via a forward link signal. Mobile stations 102-104 communicates with base stations 101 and 160 via corresponding reverse links. Each reverse link is maintained by a reverse link signal, such as reverse link signals 107-109 for respectively mobile stations 102-104. If mobile station 102 is in a soft handoff with base station 160, for example, mobile station 117 may have an additional reverse link signal 117. Every time a mobile station and a base station begin a communication link, the communicating base station and the mobile station go through a registration and acceptance process. The registration and acceptance process may have to be completed before the common communications between the mobile station and the base station are to take place. A number of base stations, such as base station 101 and 160, may use the a common AC 198 to complete the registration and acceptance process.

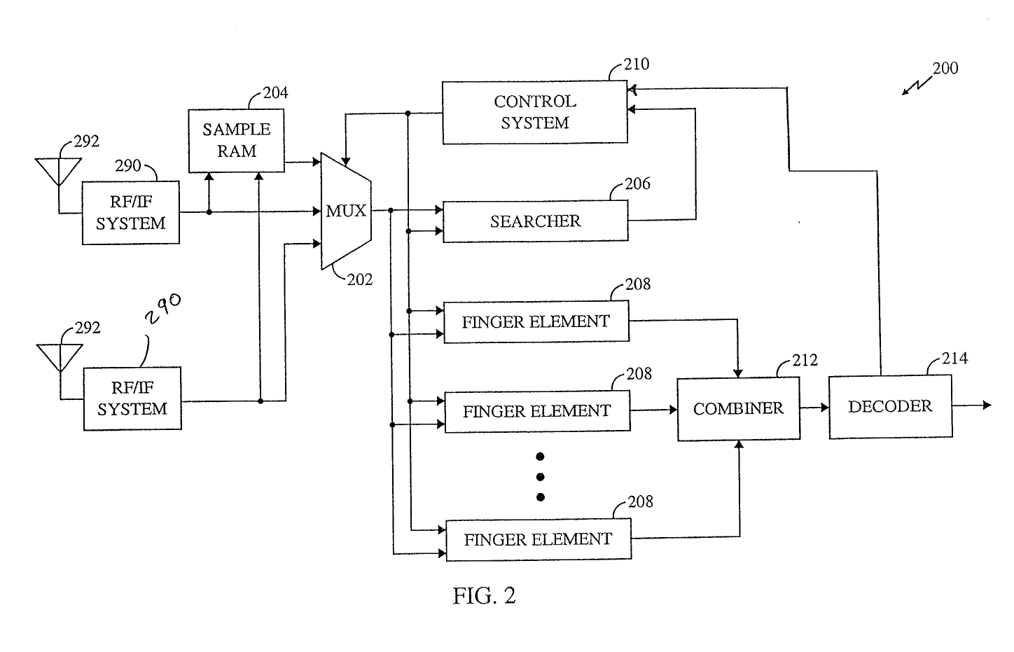

FIG. 2 illustrates a block diagram of a receiver 200 used for processing and demodulating the received CDMA signal. Receiver 200 may be used for decoding the information on the reverse and forward links signals. Received (Rx) samples may be stored in RAM 204. Receive samples are generated by a radio frequency/intermediate frequency (RF/IF) system 290 and an antenna system 292. The RF/IF system 290 and antenna system 292 may include one or more components for receiving multiple signals and RF/IF processing of the received signals for receiving diversity gain. Multiple received signals may be from a common source that has propagated through different propagation paths. Antenna system 292 receives the RF signals, and passes the RF signals to RF/IF system 290. RF/IF system 290 may be any conventional RF/IF receiver. The received RF signals are filtered, down-converted and digitized to form RX samples at base band frequencies. The samples are supplied to a demultiplexer (demux) 202. The output of demux 202 is supplied to a searcher unit 206 and finger elements 208. A control system 210 is coupled thereto. A combiner 212 couples a decoder 214 to finger elements 208. Control system 210 may be a microprocessor controlled by software, and may be located on the same integrated circuit or on a separate integrated circuit. The decoding function in decoder 214 may be in accordance with a turbo decoder or any other suitable algorithms.

During operation, receive samples are supplied to demux 202. Demux 202 supplies the samples to searcher unit 206 and finger elements 208. Control system 210 configures finger elements 208 to perform demodulation and despreading of the received signal at different time offsets based on search results from searcher unit 206. The results of the demodulation are combined and passed to decoder 214. Decoder 214 decodes the data and outputs the decoded data. The decoding process may include a process for de-encrypting the received data. Despreading of the channels is performed by multiplying the received samples with the complex conjugate of the PN sequence and assigned Walsh function at a single timing hypothesis and digitally filtering the resulting samples, often with an integrate and dump accumulator circuit (not shown). Such a technique is commonly known in the art. The decoded data may be passed on to a processor for further processing of the decoded data to maintain the communication with the transmitter. Control system 210 may also receive an input from decoder 214 for detecting whether the received data passes the message integrity requirements. The decoded crypto-sync data may be passed to control system 210 to perform the message integrity detection. If the message integrity does not pass, the receiver 200 may terminate decoding data from the same transmitter.

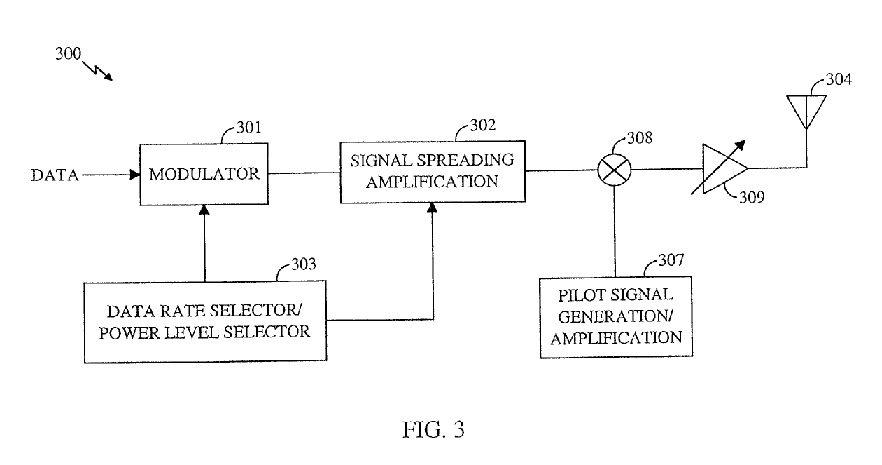

FIG. 3 illustrates a block diagram of a transmitter 300 for transmitting the reverse and forward link signals. Traffic channel data for transmission are input to a modulator 301 for modulation. The modulation may be according to any of the commonly known modulation techniques such as QAM, PSK or BPSK. The data is encoded at a data rate in modulator 301. The input data to modulator 301 may include the data for performing message integrity at a receiving destination. The data rate may be selected by a data rate and power level selector 303. For the reverse link signals, the data rate selection may be based on feedback information from a receiving base station. The data rate and power level selector 303 accordingly selects the data rate in modulator 301. The output of modulator 301 passes through a signal spreading operation and amplified in a block 302 for transmission from an antenna 304. A pilot signal is also generated in a block 307. The pilot signal is amplified to an appropriate level in block 307. The pilot signal power level may be in accordance with the channel condition at a receiving base station. The pilot signal is combined with the traffic channel signal in a combiner 308. The combined signal may be amplified in an amplifier 309 and transmitted from antenna 304. The antenna 304 may be in any number of combinations including antenna arrays and multiple input multiple output configurations. The data rate and power level selector 303 also may select a power level for the amplification level of the transmitted signal in accordance with the feedback information. The combination of the selected data rate and the power level allows proper decoding of the transmitted data at the receiving base station.

Mobile station 102 may roam from the coverage area of the base station 101 to the coverage area of the base station 160. The mobile station may go through a soft handoff process with the base stations 101 and 160. The handoff process is commonly known. The mobile station 102 continues the use of the communication services by receiving the forward link signal 161 from base station 160 and transmitting the reverse link signal 117. The AC 198 is used to authenticate and provide the encryption keys for a secure communication between a mobile station and any of the base stations 101 and 160.

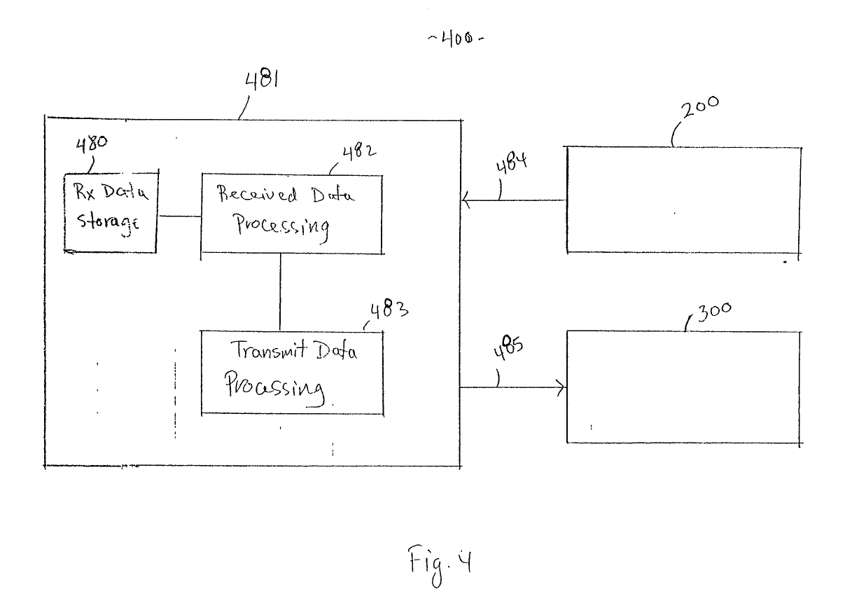

FIG. 4 depicts a general diagram of a transceiver system 400 for incorporating receiver 200 and transmitter 300 for maintaining a communication link with a destination. The transceiver 400 may be incorporated in a mobile station or a base station. A processor 481 may be coupled to receiver 200 and transmitter 300 to process the received and transmitted data. The processing of the received data includes checking for message integrity. The processing for the transmitted data includes creating and inserting the crypto-sync data into the transmitted data for the receiving destination. Various aspects of the receiver 200 and transmitter 300 may be common, even though receiver 200 and transmitter 300 are shown separately. In one aspect, receiver 200 and transmitter 300 may share a common local oscillator and a common antenna system for RF/IF receiving and transmitting. Transmitter 300 receives the data for transmission on input 485. Transmit data processing block 483 prepares the data for transmission on a transmit channel. Received data, after being decoded in decoder 214, are received at processor 400 at an input 484. Received data are processed in received data processing block 482 in processor 401. The processing of the received data generally includes checking for error in the received packets of data. For example, if a received packet of data has error at an unacceptable level, the received data processing block 482 sends an instruction to transmit data processing block 483 for making a request for retransmission of the packet of data. The request is transmitted on a transmit channel. A receive data storage unit 480 may be utilized to store the received packets of data. The processor 481 through received data processing unit 482 and transmit data processing unit 483 may maintain the message integrity between the source and destination. Various operations of processor 481 may be integrated in a single or multiple processing units. The transceiver 400 may be connected to another device. The transceiver 400 may be an integral part of the device. The device may be a computer or operates similar to a computer. The device may be connected to a data network, such as Internet. In case of incorporating the transceiver 400 in a base station, the base station through several connections may be connected to a network, such as Internet.

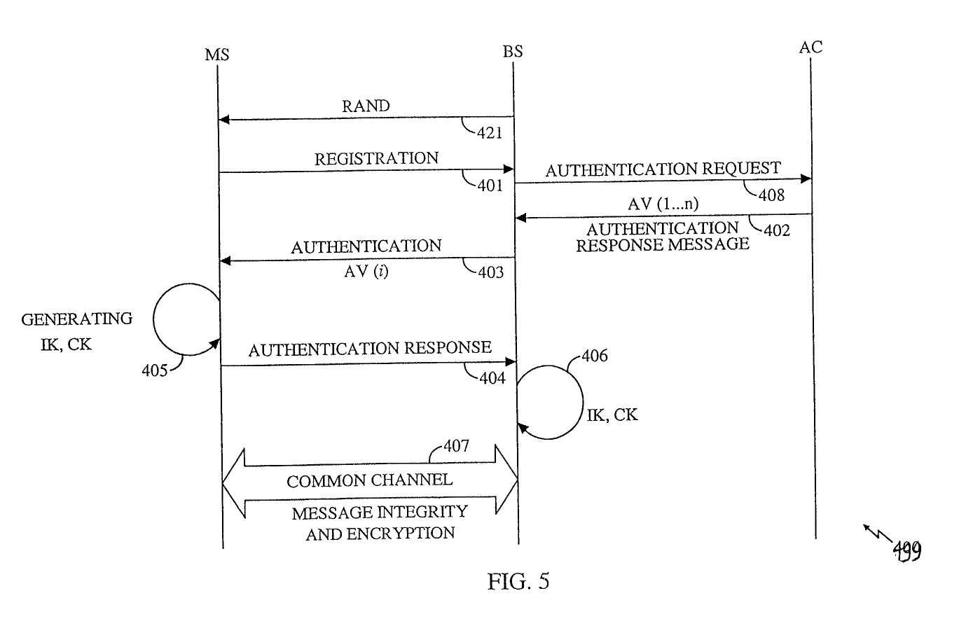

Referring to message flow 499 depicted in FIG. 5, a message flow for authentication and encryption is shown. Various aspects of the message flow 499 may be performed by transceiver 400 through processor 481 and control system 210, individually or in combination. Different communication standard may require different procedures for establishing authentication and encryption. Message flow 499 is an exemplary flow of messages for establishing an initial registration and acceptance for maintaining message integrity between a source and a destination. The message flow 499 may be used between a mobile station, a base station, as shown in FIG. 1, and the AC 198. The interface between AC 198 and MSC 199 may operate in conformance of the ANSI-41 standard, incorporated by reference herein, relevant to the operations of message integrity and encryption as outlined in the TIA/EIA-IS-2000-B. The base station broadcasts a random access number (RAND) message 421 to all mobile stations. The mobile station uses RAND to generate a registration message 401. The registration message 401 is communicated from the mobile station to the base station. The registration message 401 also includes the crypto-sync data. The crypto-sync data communicated with the registration message 401 indicates an initial security sequence number that may be used by the base station. The base station uses the initial sequence number for further communications with mobile station. The mobile station also uses the same initial sequence number. The sequence number is incremented sequentially in each subsequent communications by the base station and the mobile station. As a result of using the same initial data, the base station and the mobile station may begin and maintain a synchronized sequence numbering of the messages.

The base station then sends an authentication request message 408 to the AC 198. The AC 198 then sends an authentication response message 402. The message 402 carries a set of authentication vectors (AV) in accordance with the standard. Each AV contains a number of elements used for authentication including integrity key (IK) and cipher key (CK). The base station selects one of the authentication vectors and transmits some elements of the selected AV to the mobile station on an authentication request message 403. The elements of the AV are generated based on a root key that is kept at the AC 198. The same root key is also stored in the mobile station. The mobile station internally checks whether the communicated AV elements match the AV elements generated based on the stored root key. If the match is successful, the mobile station in effect has authenticated the base station. Based on the root key and the communicated AV elements, the mobile station locally generates IK and CK via an internal message 405. The mobile station also generates a user response (RES) message based on the communicated AV elements. The mobile station then transmits the RES message in an authentication response 404 to the base station. The base station also locally generates IK and CK via internal message 406. The base station compares the received RES message to the expected RES. If a match exists, the base station in effect has authenticated the mobile station. At this point, the communications 407 may perform message integrity and encryption in accordance with the standard. The encryption of the data is also based on the same CK.

The mobile station expects to receive a registration accepted order message from the base station to successfully complete the authentication registration and acceptance process. If the mobile station receives a registration reject order message, the mobile station may re-start the authentication registration process. After the mobile station has been through a successful authentication registration and acceptance, the mobile station includes a message authentication code (MAC) in the communication with the base station. The presence of the MAC in each communicated packet of data allows the base station to perform local authentication with the mobile station for every received communication. Moreover, the mobile station may include the MAC and a partial form of the crypto-sync in each transmission to the base station. After receiving the initial registration acceptance order message, if the crypto-sync synchronization fail, the mobile station may receive a reject order message from the base station. In such a case, in accordance with various aspects of the invention, the mobile station may synchronize the crypto-sync data at the base station and the mobile station without performing a complete authentication registration process.

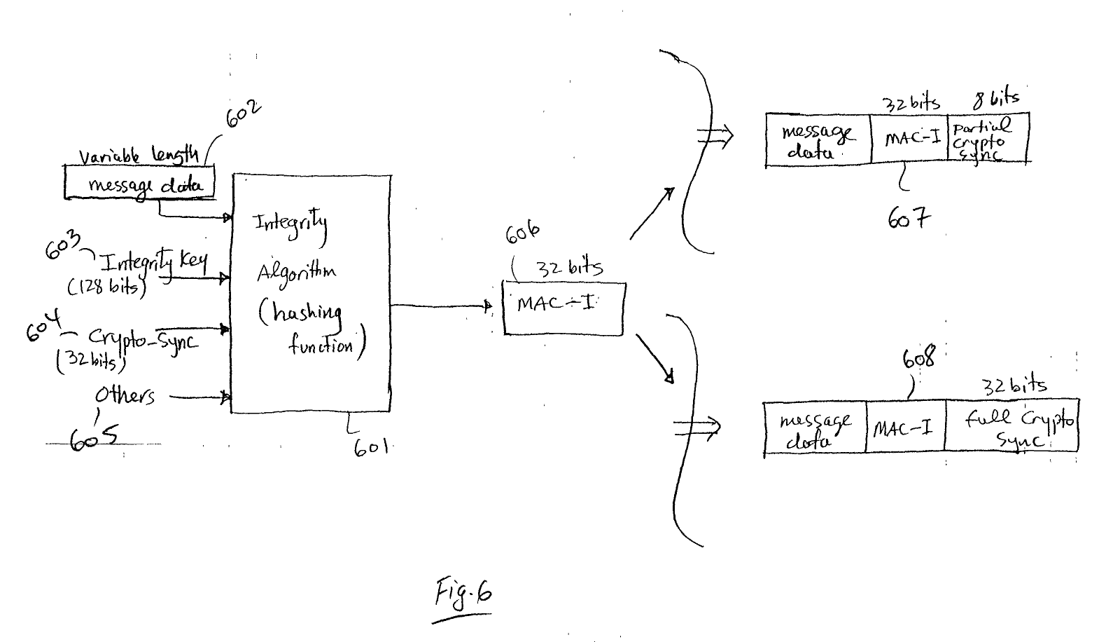

Referring to FIG. 6, the process for generating the MAC and the data packet for transmission is illustrated. The processor 481 or transmit data processing unit 483, or in combination, may perform various aspects of the process as illustrated in FIG. 6. A block 601 may perform a hashing function on the input data to produce, for example, a 32 bit MAC 606. The hashing function performed in block 601 may be in accordance with a selected integrity algorithm in the communication system 100. Various aspects of the algorithm are described in relevant sections of the standard, and generally known by one ordinary skilled in the art. The input data to integrity algorithm block 601 includes message data 602, an integrity key 603, a crypto-sync data and possibly other data. The message data 602 may be encrypted in accordance with a selected encryption. The message data 602 may have different length at different times. The integrity key 603 may be 128 bits, for example. The crypto-sync 604 may be 32 bits long. The crypto-sync is the security sequence number used at the transmitter and receive to keep track of the transmitted messages. The crypto-sync data at the transmitter and the receiver are synchronized initially. After the initial synchronization, only a partial part of the crypto-sync data is transmitted from the transmitter to the receiver. After the MAC 606 is produced, the message data 602, MAC 606 and a partial form of the crypto-sync 604 are combined to form a data packet 607 for transmission. On the receiving end, the synchronization of the crypto-sync data is maintained based on the partial form of the crypto-sync data communicated in the data packet 607. If the synchronization of the crypto-sync data is lost, the transmitter may send the data packet 608 in accordance with the various aspects of the invention to reestablish the crypto-sync synchronization without going through an authentication registration process. The data packet 608 includes the full form of the crypto-sync data 604. When the data packet 608 is transmitted with a full form of the crypto-sync data 604, the transmitter may select a new security sequence number other than what has been used prior to loss of the crypto-sync synchronization. The data packet 608 may be included in a security mode request message (SMRM) and transmitted to the receiving station. Transmission of the SMRM may be in response to receiving a reject order message from the receiving station due to loss of the crypto-sync synchronization. The receiving station, as a result, may use the full form of the crypto-sync data communicated on the data packet 608 in a SMRM to reestablish a synchronization of the crypto-sync data. The receiver may be a base station and the transmitter may be a mobile station as shown in communication system 100.

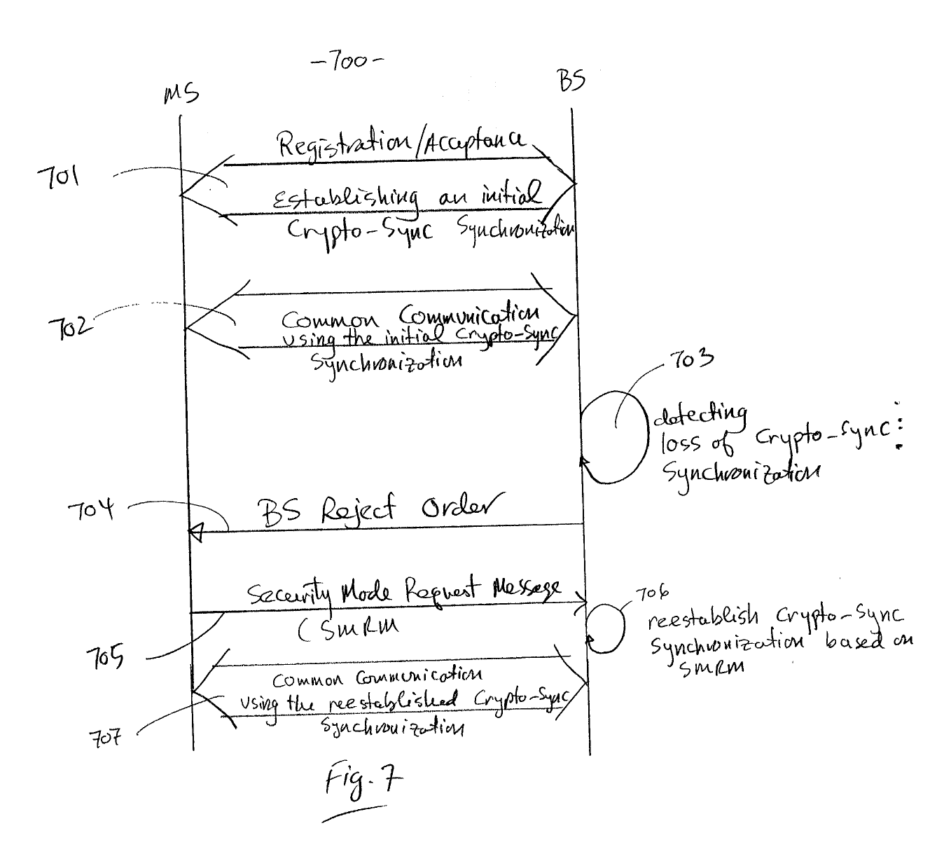

Referring to FIG. 7, a flow of messages 700 between a base station and a mobile station in accordance with various aspects of the invention for reestablishing crypto-sync data synchronization between the base station and the mobile station is shown. The messages 701 including the initial registration and acceptance order between the base station and mobile station are communicated. The messages 701 include an acceptance order which establishes an initial crypto-sync data synchronization between the base station and the mobile station. The common communication messages 702 may take place between the base station and the mobile station. The common communication messages 702 includes the process of using message integrity as outlined in the form of a packet data including data packet 607 that includes a partial form of the crypto-sync data. An internally generated message 703 at the base station may indicate loss of crypto-sync synchronization. The message 703 is generated when the receive processing at the base station detects loss of the crypto-sync synchronization. The synchronization may be lost when the expected security sequence number at the base station does not match a security sequence number as indicated by the partial form of the crypto-sync data as communicated in the data packet 607. The base station uses the partial crypto-sync data to form a complete security sequence number as expected with reference to the previously received security sequence numbers. When the partial crypto-sync data can not produce the expected security sequence number, the base station may indicate detection of loss of crypto-sync synchronization. As a result, the base station transmits a reject order message 704 to the mobile station. The mobile station upon receiving the reject order message 704, after the initial synchronization performed through the messages 701, may transmit a SMRM message 705 to the base station. The SMRM message 705 includes the form of the data packet 608 which includes a full crypto-sync data. The base station upon receiving the SMRM 705 after sending the reject order 704 may use the full crypto-sync data to reestablish the crypto-sync data synchronization. An internal message 706 may be generated to indicate reestablishing the crypto-sync synchronization based on the crypto-sync data communicated in the SMRM. The common communication 707, thereafter, may use the reestablished crypto-sync synchronization to perform the message integrity without going through another round of registration and acceptance process.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method for reestablishing crypto-sync synchronization between a mobile station and a base station in a communication system, comprising:
establishing an initial crypto-sync synchronization between said mobile station and said base station through a registration and acceptance order process;
detecting loss of said initial crypto-sync synchronization at said base station;
receiving a base station reject order message at said mobile station;
transmitting a security mode request message from said mobile station to said base station, wherein said security mode request message includes a full form of crypto-sync data for said reestablishing crypto-sync synchronization between said mobile station and said base station without going through another round of said registration and acceptance order process.

2. The method as recited in claim 1 further comprising:
maintaining a common communication between said mobile station and said base station while using a partial form of crypto-sync data for maintaining said initial crypto-sync synchronization.

3. The method as recited in claim 1 further comprising:
maintaining a common communication between said mobile station and said base station while using a partial form of crypto-sync data for maintaining said reestablished crypto-sync synchronization.

4. An apparatus for reestablishing crypto-sync synchronization between a mobile station and a base station in a communication system, comprising:
means for establishing an initial crypto-sync synchronization between said mobile station and said base station through a registration and acceptance order process;
means for detecting loss of said initial crypto-sync synchronization at said base station;
means for receiving a base station reject order message at said mobile station;
means for transmitting a security mode request message from said mobile station to said base station, wherein said security mode request message includes a full form of crypto-sync data for said reestablishing crypto-sync synchronization between said mobile station and said base station without going through another round of said registration and acceptance order process.

5. The apparatus as recited in claim 4 further comprising:
means for maintaining a common communication between said mobile station and said base station while using a partial form of crypto-sync data for maintaining said initial crypto-sync synchronization.

6. The apparatus as recited in claim 4 further comprising:
means for maintaining a common communication between said mobile station and said base station while using a partial form of crypto-sync data for maintaining said reestablished crypto-sync synchronization.

7. A processor for reestablishing crypto-sync synchronization between a mobile station and a base station in a communication system, comprising:
processing means for establishing an initial crypto-sync synchronization between said mobile station and said base station through a registration and acceptance order process, for receiving a message indicating detection of loss of said initial crypto-sync synchronization at said base station, for receiving a base station reject order message at said mobile station, and for transmitting a security mode request message from said mobile station to said base station, wherein said security mode request message includes a full form of crypto-sync data for said reestablishing crypto-sync synchronization between said mobile station and said base station without going through another round of said registration and acceptance order process.

8. The processor as recited in claim 7 further comprising:
processing means for maintaining a common communication between said mobile station and said base station while using a partial form of crypto-sync data for maintaining said initial crypto-sync synchronization.

9. The processor as recited in claim 7 further comprising:
processing means for maintaining a common communication between said mobile station and said base station while using a partial form of crypto-sync data for maintaining said reestablished crypto-sync synchronization.

10. A processor for reestablishing crypto-sync synchronization between a mobile station and a base station in a communication system, comprising:
processing means for establishing an initial crypto-sync synchronization between said mobile station and said base station through a registration and acceptance process, for detecting loss of said initial crypto-sync synchronization at said base station, for generating a message indicating said detecting, for generating a base station reject order message, and for receiving a security mode request message from said mobile station, wherein said security mode request message includes a full form of crypto-sync data for said reestablishing crypto-sync synchronization between said mobile station and said base station without going through another round of said registration and acceptance process.

11. The processor as recited in claim 10 further comprising:
processing means for maintaining a common communication between said mobile station and said base station while using a partial form of crypto-sync data for maintaining said initial crypto-sync synchronization.

12. The processor as recited in claim 10 further comprising:
processing means for maintaining a common communication between said mobile station and said base station while using a partial form of crypto-sync data for maintaining said reestablished crypto-sync synchronization.

13. A mobile station for reestablishing crypto-sync synchronization with a base station in a communication system, comprising:
a processor for establishing an initial crypto-sync synchronization between said mobile station and said base station through a registration and acceptance order process;
a receiver for receiving a message indicating detection of loss of said initial crypto-sync synchronization at said base station, for receiving a base station reject order message from said base station;
a transmitter for transmitting a security mode request message from said mobile station to said base station, wherein said security mode request message includes a full form of crypto-sync data for said reestablishing crypto-sync synchronization between said mobile station and said base station without going through another round of said registration and acceptance order process.

14. The mobile station as recited in claim 13 wherein said processor, said receiver and said transmitter are further for maintaining a common communication between said mobile station and said base station while using a partial form of crypto-sync data for maintaining said initial crypto-sync synchronization.

15. The processor as recited in claim 13 wherein said processor, said receiver and said transmitter are further for maintaining a common communication between said mobile station and said base station while using a partial form of crypto-sync data for maintaining said reestablished crypto-sync synchronization.

16. A base station for reestablishing crypto-sync synchronization with a mobile station in a communication system, comprising:
a processor for establishing an initial crypto-sync synchronization between said mobile station and said base station through a registration and acceptance process, for detecting loss of said initial crypto-sync synchronization at said base station;
a transmitter for transmitting a base station reject order message indicating said detecting;
a receiver for receiving a security mode request message from said mobile station, wherein said security mode request message includes a full form of crypto-sync data for said reestablishing crypto-sync synchronization between said mobile station and said base station without going through another round of said registration and acceptance process.

17. The base station as recited in claim 16 wherein said processor, said transmitter and said receiver are further for maintaining a common communication between said mobile station and said base station while using a partial form of crypto-sync data for maintaining said initial crypto-sync synchronization.

18. The processor as recited in claim 16 wherein said processor, said transmitter and said receiver are further for maintaining a common communication between said mobile station and said base station while using a partial form of crypto-sync data for maintaining said reestablished crypto-sync synchronization.
